(19) United States
(12) Patent Application Publication
(10) Pub. No.: US 2024/0240503 A1
(43) Pub. Date: Jul. 18, 2024

(54) GUIDE BLOCK

(71) Applicant: AISIN (SUZHOU) TECHNICAL CENTER CO.,LTD., Suzhou (CN)

(72) Inventors: Ryuta FUKADA, Suzhou (CN); Jie Feng ZHANG, Suzhou (CN)

(73) Assignee: AISIN (SUZHOU) TECHNICAL CENTER CO.,LTD., Suzhou (CN)

(21) Appl. No.: 18/474,403

(22) Filed: Sep. 26, 2023

(30) Foreign Application Priority Data
Jan. 16, 2023 (CN) 202320118072.0

(51) Int. Cl. E05D 15/10; B60J 7/043

(52) U.S. Cl. CPC E05D 15/10; B60J 7/043

(57) ABSTRACT

The present disclosure provides a guide block that can be universal to the left and right guide rails of a sunroof device, thereby reducing manufacturing cost and component types. The guide block for guiding a sunroof panel comprises a pair of left and right guide channels, wherein a sliding surface of at least one of the left and right guide channels is connected to a sliding surface of a guide rail of the sunroof panel at one end thereof in a front-rear direction of a vehicle, and a guided part of the sunroof panel enters the guide block from the sliding surface of the guide rail and slides on the sliding surface of the at least one; and a guide rail locking part arranged on one end of the guide block to fix the guide block to the guide rail.

### FIELD OF THE DISCLOSURE

The present disclosure relates to a guide block, in particular to a guide block for guiding actions of a sunroof panel of a vehicle in a sunroof device of the vehicle.

### BACKGROUND

In a sunroof device of a vehicle, a guide block is mounted to guide movement of a sunroof panel, enabling it to be smoothly opened and closed.

Patent Document 1 discloses a guide assembly for a sunroof device, which has a guide block connected to a guide rail. The guide block has only one forming plate part and only one guide channel is provided on one side of the forming plate part to guide actions of the sunroof panel. One end of a sliding surface of the guide channel is connected to a sliding surface of the guide rail of the sunroof panel. A guided part of the sunroof panel can enter the guide block from the sliding surface of the guide rail and slide on the sliding surface of the guide channel. In addition, the guide block has a guide rail locking part that fixes the guide block to the guide rail from the up-down direction.

### CITATION LIST

### Patent Literature

[Patent Literature 1]
Chinese utility model application publication No. CN210139769U

### SUMMARY

However, due to the fact that the guide block has only one forming plate part with the guide channel on only one side thereof, when mounting such a guide block to the sunroof device, it is necessary to prepare two kinds of guide blocks having guide channels on opposite faces to each other to be mounted on both left and right guide rails so as to guide the movement of the sunroof panel. This leads to the need for manufacturing and preparing two kinds of guide blocks with different shapes, thereby increasing manufacturing cost and types of components.

The purpose of the present disclosure is to provide a guide block that can be universal to the left and right guide rails of the sunroof device, thereby reducing manufacturing cost and component types.

An embodiment of the present disclosure relates to a guide block for guiding a sunroof panel, comprising: a pair of left and right guide channels, wherein a sliding surface of at least one of the left and right guide channels is connected to a sliding surface of a guide rail of the sunroof panel at one end thereof in a front-rear direction of a vehicle, and a guided part of the sunroof panel enters the guide block from the sliding surface of the guide rail and slides on the sliding surface of the at least one of the left and right guide channels; and a guide rail locking part arranged on one end of the guide block to fix the guide block to the guide rail.

According to the present disclosure with the above structure, since there is a pair of left and right guide channels, compared to a structure with only one guide channel, the same guide block can be applied to both the left and right guide rails of the sunroof device, without the need to provide specific guide blocks for each side of the guide rails of the sunroof device, thereby increasing the universality of the guide block, and thus reducing manufacturing cost and component types.

In addition, in the present disclosure, it is preferred that the guide block further comprises a pair of left and right forming plate parts arranged with an interval in a width direction of the vehicle, the left guide channel is formed on the left forming plate part, and the right guide channel is formed on the right forming plate part.

According to the present disclosure with the above structure, the strength of the guide channel can be improved due to the two guide channels being arranged on the left and right forming plate parts.

In addition, in the present disclosure, it is preferred that the guided part of the sunroof panel slides on the sliding surfaces of both the left and right guide channels.

According to the present disclosure with the above structure, since the guided part of the sunroof panel slides on the sliding surfaces of both the left and right guide channels, compared to sliding only on the sliding surface of a single side guide channel, it can support the guided parts bilaterally, thereby improving the stability of the guided part during sliding.

In addition, in the present disclosure, it is preferred that one end of each of the pair of left and right forming plate parts is provided with the guide rail locking part.

Therefore, due to the two guide rail locking parts arranged with an interval in the width direction of the vehicle, the guide block can be fixed to the guide rail bilaterally, thereby improving the rigidity of the guide block.

In addition, in the present disclosure, it is preferred that the pair of left and right guide rail locking parts protrude from one ends of the pair of left and right forming plate parts, respectively, and are inserted into a pair of corresponding concave parts of the guide rail, respectively, thereby fixing the guide block to the guide rail.

Therefore, the guide block can be fixed to the guide rail using a simple structure such as concave and convex parts.

In addition, in the present disclosure, it is preferred that the guide block further comprises includes a bottom plate arranged at the bottom of the guide block and connected to the pair of left and right forming plate parts; and a side plate extending upwards from one end of the bottom plate opposite to the guide rail locking parts and connected to the pair of left and right forming plate parts, wherein a drainage port is arranged on the side plate.

According to the present disclosure with the above structure, water within the guide block can be discharged.

In addition, in the present disclosure, it is preferred that the guide block further comprises a mounting part that extends horizontally from an upper end of the side plate to a front side, and the guide block is fixed to a housing of a sunroof device through the mounting part.

By providing the mounting part, the guide block can be stably mounted on the housing of the sunroof device.

In addition, in the present disclosure, it is preferred that the mounting part is provided with a mounting hole for inserting a mounting bolt.

Therefore, it is possible to fix the guide block by a simple component such as a bolt.

In addition, in the present disclosure, it is preferred that a concave part concaved inwards is arranged on an outer side of the forming plate part. Moreover, there is a plurality of the concave parts with a rib formed between two adjacent concave parts.

Therefore, compared to a structure without the concave part, it is possible to reduce the weight of the guide block and save manufacturing material.

### BRIEF DESCRIPTION OF THE DRAWINGS

FIG. 1 is a perspective view showing a guide block for guiding actions of a sunroof panel according to the present disclosure;

FIG. 2 is a perspective view showing the guide block viewed from a different angle from FIG. 1 according to the present disclosure;

FIG. 3 is a side view showing the guide block viewed from the right side;

FIG. 4 is a schematic view showing a state of the guide block mounted on the guide rail of the sunroof panel;

FIG. 5 is a schematic view showing a drainage path for discharging the water within the guide block from a drainage port.

### DETAILED DESCRIPTION

Below, the preferred embodiments of the present disclosure will be explained with reference to the drawings. In the following description, expressions about the directions such as “up”, “down”, “left”, “right”, “front”, “rear” refer to the directions of a vehicle in the view of a driver sitting in a driver's seat.

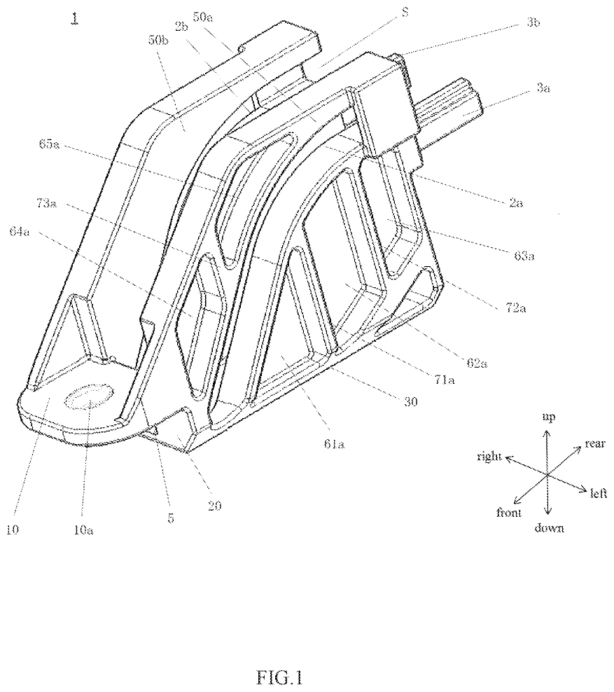

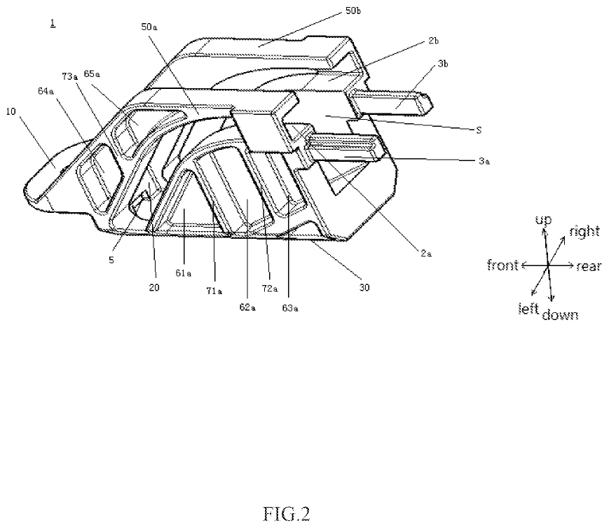

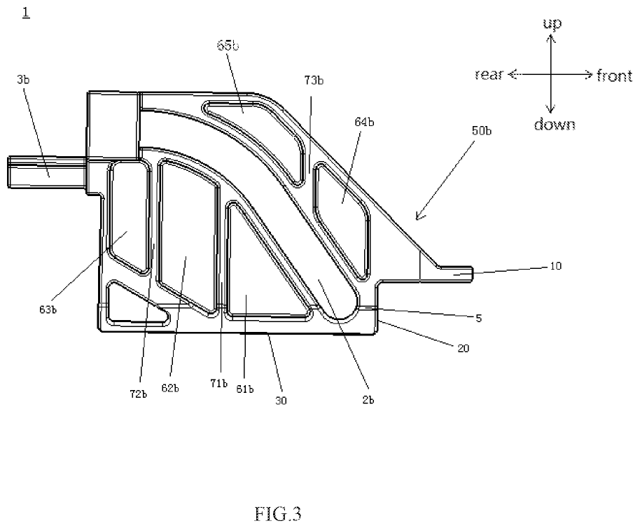

FIGS. 1 to 3 are schematic views showing a guide block at different angles. In the figures, the guide block 1 is a symmetrical shape with the same shape on the left side as the shape on the right side, including a pair of left and right forming plate parts 50a, 50b, a side plate 20, and a bottom plate 30.

The right forming plate part 50b and the left forming plate part 50a are arranged at intervals S in a width direction of the vehicle. In this preferred embodiment, the structures and shapes of the right forming plate part 50b and the left forming plate part 50a are identical.

The left forming plate part 50a is formed with a guide channel 2a, which extends deviously downwards from a rear end towards a front end of the left forming plate part 50a. The guide channel 2a is formed throughout a thickness direction of the left forming plate part 50a.

On the left side, as an outer side, of the left forming plate part 50a, there is provided with concave parts 61a˜65a that are concave towards the right side. Among them, the concave parts 61a˜63a that are sequentially arranged from front to rear and are located below the guide channel 2a, with a rib 71a being formed between the concave parts 61a and 62a, and a rib 72a being formed between the concave parts 62a and 63a. The concave parts 64a and 65a that are arranged sequentially from front to rear are located above the guide channel 2a, with a rib 73a being formed between the concave parts 64a and 65a

Similar to the left forming plate part 50a, a guide channel 2b is formed on the right forming plate part 50b, and concave parts 61b˜65b that are concave towards the left side are provided on the right side, as an outer side, of the forming plate part 50b. Ribs 71b˜73b are formed between adjacent concave parts.

A guide rail locking part 3a is arranged on the rear end of the left forming plate part 50a, and protrudes from the rear end towards the rear. A guide rail locking part 3b is arranged on the rear end of the right forming plate part 50b, and protrudes from the rear end towards the rear. The guide rail locking parts 3a and 3b are used for fixing the guide block 1 to the guide rail A of the sunroof panel.

The bottom plate 30 is arranged at the bottom of the guide block 1 and connected to the pair of left and right forming plate parts 50a and 50b.

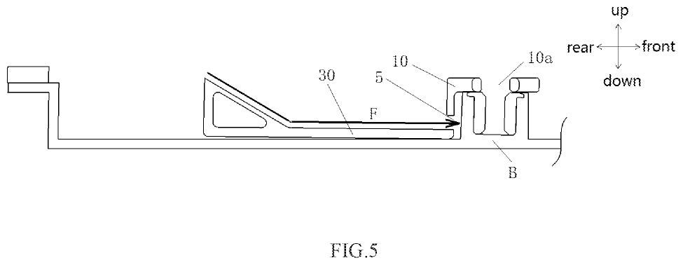

A side plate 20 extends upwards from a front end of the bottom plate 30 and is connected to the left forming plate part 50a and the right forming plate part 50b. A drainage port 5 is arranged on the side plate 20 for discharging the water. The drainage port 5 is preferably arranged in a part of the side plate 20 connected to the bottom plate 30. As shown in FIG. 5, the water within the guide block 1 can flow along an upper surface of the bottom plate 30 to the drainage port 5 and be discharged from the drainage port 5, along a drainage path shown by arrow F.

There is a mounting part 10 on a front end of the guide block 1. The mounting part 10 is used for fixing the guide block 1 to a housing B of the sunroof device. The mounting part 10 extends horizontally from an upper end of the side plate 20 to a front side. The mounting part 10 is provided with a mounting hole 10a vertically penetrating therethrough, through which a mounting bolt is inserted. By the mounting hole 10a, the guide block 1 can be fixed to the housing B of the sunroof device.

Next, the mounting and operation of the guide block 1 will be explained.

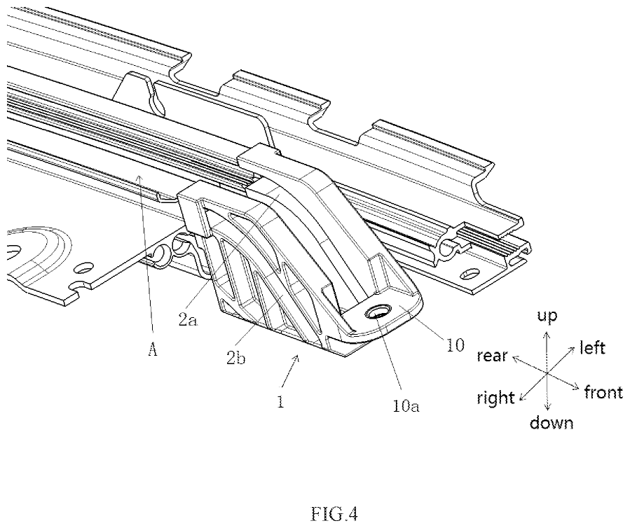

FIG. 4 is a schematic view showing a state of the guide block 1 mounted on guide rail A of the sunroof panel. In order to clearly show the technical solution of the present disclosure, only the guide rail A and the guide block 1 are shown, and other structures can adopt any well-known structure in the sunroof field. The pair of left and right guide rail locking parts 3a and 3b of the guide block 1 (see FIGS. 1˜3) are inserted into a pair of corresponding concave parts on the front end of the guide rail A, so that the guide block 1 is fixed to the guide rail A. After being mounted, sliding surfaces of the pair of left and right guide channels 2a and 2b are connected to sliding surfaces of the guide rail A of the sunroof panel at the rear end thereof, forming a smooth sliding surface located on the same surface.

In addition, as shown in FIG. 5, the mounting part 10 of the guide block 1 is fixed to the housing B of the sunroof device by inserting the mounting bolt (not shown) into the mounting hole 10a, thereby completing the fixing of the front end of the guide block 1 to the sunroof device.

When the sunroof panel performs opening and closing actions, such as when the sunroof panel performs a closing action, a guided part of the sunroof panel enters the guide block 1 from the sliding surface of the guide rail A and then slides on the sliding surfaces of both the left and right guide channels 2a and 2b. Therefore, the closing action of the sunroof panel is guided by the guide block 1, and more specifically, by the guide channels 2a and 2b of the guide block 1. When the sunroof panel performs an opening action, the guided part of the sunroof panel transitions to the sliding surface of the guide rail A along the sliding surfaces of the pair of left and right guide channels 2a and 2b of the guide block 1, so that the opening action of the sunroof panel is guided by the guide block 1 and then by the guide rail A.

The guided part of the sunroof panel here can be a guide roller directly mounted on the sunroof panel, or be a guide rod hinged to the sunroof panel and/or a pin on the guide rod.

Next, the effects of the present disclosure will be explained.

Since there is a pair of left and right guide channels 2a and 2b, compared to a structure with only one guide channel, the same guide block can be applied to both the left and right guide rails of the sunroof device, without the need to provide specific guide blocks for each side of the guide rails of the sunroof device, thereby increasing the universality of the guide block, and thus reducing manufacturing cost and component types.

As the pair of left and right guide channels 2a and 2b are provided separately in two forming plate parts 50a and 50b, it is possible to improve the strength of guide channels 2a and 2b.

In addition, as the guided part of the sunroof panel slides on the sliding surfaces of both the left and right guide channels 2a and 26, it is possible to support the guided part bilaterally, thereby improving the stability of the guided part during sliding.

The left and right guide rail locking parts 3a and 3b are provided on one end of each of the pair of left and right forming plate parts 50a and 50b, respectively. Due to the two guide rail locking parts 3a and 3b arranged with interval in the width direction of the vehicle, the guide block can be fixed to the guide rail bilaterally, thereby improving the rigidity of the guide block.

In addition, the pair of left and right guide rail locking parts 3a and 3b, which protrude from one ends of the pair of left and right forming plate parts 50a and 50b, are inserted into the pair of corresponding concave parts of the guide rail A of the sunroof panel. Therefore, the guide block 1 can be fixed to the guide rail A using a simple structure such as concave and convex parts.

By providing the drainage port 5 on the side plate 20, the water within the guide block 1 can be discharged timely.

In addition, the guide block 1 has the mounting part 10, which has the mounting hole 10a for inserting a mounting bolt. Therefore, the guide block 1 can be stably mounted on the housing B of the sunroof device by a simple component such as a bolt.

In addition, concave parts 61a˜65a and 61b˜65b concaved inwards are arranged on the outer side of the forming plate parts 50a and 50b, and ribs are formed between the adjacent concave parts. Therefore, compared to structures without concave parts, it is possible to reduce the weight of the guide block 1 and save manufacturing material.

The preferred embodiment of the present disclosure has been explained above, but the present disclosure is not limited to this and can undergo various modifications and changes as follows.

In the preferred embodiment described above, the guide channels 2a and 2b are respectively arranged on the pair of left and right forming plate parts 50a and 50b formed with the interval S, but it is not limited to this. For example, the guide block 1 may have only one forming plate part, and a pair of guide channels separated by the forming plate part may be formed on both left and right sides of the forming plate part by ribs protruding from the sides outwards. In this case, the guided part of the sunroof panel slides in one of the two guide channels depending on the left or right guide rail where the guided part of the sunroof panel is located.

In the preferred embodiment described above, the shape and structure of the left forming plate part 50a and the right forming plate part 50b are identical, but it is not limited to this. As long as there are guide channels 2a and 2b respectively formed on the left the forming plate part 50a and the right forming plate part 50b, which can enable the guide block 1 to be mounted and applied on both the left guide rail and the right guide rail of the sunroof device, the shapes of the left forming plate part 50a and the right forming plate part 50b are not particularly limited.

In the preferred embodiment described above, the guide channels 2a and 2b are formed through the thickness direction of the forming plate parts 50a and 50b, but it is not limited to this. As long as the guided part of the sunroof panel can be guided to slide, the guide channels 2a and 2b can also not penetrate the forming plate parts 50a and 50b.

In addition, in the preferred embodiment described above, the guided part of the sunroof panel slides simultaneously on the sliding surfaces of both the left and right guide channels 2a and 2b of the guide block 1, but it is not limited to this. The guided part of the sunroof panel can also only slide on the sliding surface of one of the left and right guide channels 2a and 2b of the guide block 1.

In addition, in the preferred embodiment described above, the guide rail locking parts 3a and 3b are respectively formed on the rear end of the pair of left and right forming plate part 50a and 50b, but the guide rail locking part can also be formed only on the rear end of one forming plate part or at other position of the guide block.

The pair of left and right guide rail locking parts 3a and 3b are formed to protrude from the rear ends of the forming plate parts 50a and 50b, but the configuration of the guide rail locking parts is not limited to this. As long as the guide block 1 can be fixed to the guide rail A, the guide rail locking part can be set in any way, for example, the guide rail locking parts are arranged to be concave from the rear end surfaces of the forming plate parts 50a and 50b, and there are protrusions corresponding to the concave parts arranged on the guide rail, and the guide block 1 is fixed to the guide rail A by the engagement of the concave parts and the protrusions.

In addition, in the preferred embodiment described above, the drainage port 5 is provided in a part of the side plate 20 connected to the bottom plate 30, but the position of the drainage port 5 is not limited to this. As long as it can discharge the water some extent, the drainage port 5 can also be arranged on other parts of the side plate 20, or it can also be arranged on other positions of the guide block 1 rather than on the side plate 20. In addition, the side plate and the drainage port can also be omitted.

In the preferred embodiment described above, there is a mounting part 10 on the front end of the guide block 1, which extends from the upper end of the side plate 20 to the front side. However, the mounting part may not be so arranged. As long as the guide block 1 can be fixed to the housing of the sunroof device, the arranging position and shape of the mounting part are not particularly limited.

The mounting part 10 of the preferred embodiment described above has a mounting hole 10a for inserting a mounting bolt, but the guide block of the present disclosure can also be fixed without the mounting bolt, for example, the guide block can be fixed to the housing of the sunroof device by riveting, snapping, welding, or the like.

In addition, in the preferred embodiment described above, multiple concave parts 61a˜65a, 61b˜65b concaved inwards are formed on the outer side of the forming plate parts 50a and 50b, and ribs 71a˜73a, 71b˜73b are arranged between adjacent concave parts. However, the present disclosure is not limited to this. The concave parts may not be provided or only one concave part may be provided. In addition, the concave part can be arranged at any position of the forming plate parts 50a and 50b.

In the preferred embodiment described above, the guide block 1 is mounted on the front side of the guide rail, but the guide block can also be applied to the rear side of the guide rail, according to the front-rear position of the movable sunroof panel on the roof and the opening and closing direction of the sunroof panel.

The above description describes the guide block applied to the sunroof device of vehicle, but the application of the guide block in the present disclosure is not limited to this, for example, the guide block can also be applied in the guidance of the house sunroof, etc.

The above explains the embodiments of the present disclosure. However, the present disclosure is not limited to the aforementioned embodiments. The embodiments obtained by technical personnel in this field who can make appropriate changes, combinations, and deletions to the above-mentioned constituent elements are also included in the technical scope to be protected by the present disclosure.

### REFERENCE SIGNS LIST

1 guide block
2a, 2b guide channel
3a,3b guide rail locking part
5 drainage port
10 mounting part
10a mounting hole
20 side plate
30 bottom plate
50a, 50b forming plate part
61a˜65a, 61b˜65b concave part
71a˜73a, 71b˜73b rib
A guide rail
B housing
S interval

1. A guide block for guiding a sunroof panel, comprising:
a pair of left and right guide channels, wherein a sliding surface of at least one of the left and right guide channels is connected to a sliding surface of a guide rail of the sunroof panel at one end thereof in a front-rear direction of a vehicle, and a guided part of the sunroof panel enters the guide block from the sliding surface of the guide rail and slides on the sliding surface of the at least one of the left and right guide channels; and
a guide rail locking part arranged on one end of the guide block to fix the guide block to the guide rail.

2. The guide block according to claim 1, further comprising a pair of left and right forming plate parts arranged with an interval in a width direction of the vehicle,
the left guide channel is formed on the left forming plate part, and the right guide channel is formed on the right forming plate part.

3. The guide block according to claim 2, wherein,
the guided part of the sunroof panel slides on the sliding surfaces of both the left and right guide channels.

4. The guide block according to claim 3, wherein,
one end of each of the pair of left and right forming plate parts is provided with the guide rail locking part.

5. The guide block according to claim 4, wherein,
the pair of left and right guide rail locking parts protrude from one ends of the pair of left and right forming plate parts, respectively, and are inserted into a pair of corresponding concave parts of the guide rail, respectively, thereby fixing the guide block to the guide rail.

6. The guide block according to claim 2, further comprising:
a bottom plate arranged at the bottom of the guide block and connected to the pair of left and right forming plate parts; and
a side plate extending upwards from one end of the bottom plate opposite to the guide rail locking parts and connected to the pair of left and right forming plate parts,
wherein a drainage port is arranged on the side plate.

7. The guide block according to claim 6, further comprising a mounting part that extends horizontally from an upper end of the side plate to a front side, and the guide block is fixed to a housing of a sunroof device through the mounting part.

8. The guide block according to claim 7, wherein,
the mounting part is provided with a mounting hole for inserting a mounting bolt.

9. The guide block according to claim 2, wherein,
a concave part concaved inwards is arranged on an outer side of the forming plate part.

10. The guide block according to claim 9, wherein,
there is a plurality of the concave parts with a rib formed between two adjacent concave parts.
